(19) United States
(12) Patent Application Publication
(10) Pub. No.: US 2008/0019119 A1
(43) Pub. Date: Jan. 24, 2008

(54) Footwear Illumination Assembly

(76) Inventor: Jez Marston, Rockville, MD (US)

Correspondence Address: CAHN & SAMUELS LLP, 1100 17th STREET NW, SUITE 401, WASHINGTON, DC, 20036, US

(21) Appl. No.: 11/753,525

(22) Filed: May 24, 2007

Related U.S. Application Data
(63) Continuation-in-part of application No. PCT/US06/05927, filed on Feb. 21, 2006.
(60) Provisional application No. 60/808,156, filed on May 25, 2006.
(60) Provisional application No. 60/736,316, filed on Nov. 15, 2005.

(51) Int. Cl. F21V 21/08; A43B 13/00; A43D 8/00

(52) U.S. Cl. 362/103; 12/146 B; 36/137

(57) ABSTRACT

Illuminated footwear assemblies that durably and reliably enhance user's distinctiveness and safety. The illuminated footwear assembly includes a footwear upper attached to a sole assembly that includes a translucent structural layer sandwiched between a midsole and an outsole. The translucent structural layer includes a tubular aperture that extends along a perimeter wherein an illumination assembly is disposed in the tubular aperture. The illumination assembly includes a control circuit and light sources, such as LEDs, that transmit light through the transparent structural layer. The illumination assembly, including the light sources and control circuit, is fully flexible and encased in a durable, flexible polymer-like material that protects the assembly. A user actuatable switch located on the footwear item is coupled to the illumination assembly to activate and deactivate the various functions of the assembly.

This application claims the benefit of U.S. Provisional Application No. 60/808,156, filed May 25, 2006. This application is a continuation-in-part of PCT Application No. PCT/US2006/005927, filed Feb. 21, 2006, which designates the U.S. and claims the benefit of U.S. Provisional Application No. 60/736,316, filed Nov. 15, 2005. Each of the foregoing applications is incorporated herein by reference.

### TECHNICAL FIELD

The present invention relates generally to the field of illuminated footwear. More particularly, the present invention relates to durable and reliable footwear illumination assemblies that provide user-controlled illumination of footwear that enhances the distinctiveness and safety of users.

### BACKGROUND ART

Illuminated footwear is popular with people of all ages and demographic groups. This popularity can be attributed to a variety of benefits associated with illumination, including fashion appeal and increased safety. Young children are fascinated by lights and colors and are especially pleased when their shoes blink or flash as they walk. Teens and young adults, as a group, are particularly fashion conscious and often seek new and distinctive ways to express themselves. This self expression is often evident in their manner of dress, including their choice of footwear. Further, teens and young adults frequently make sneakers their casual shoe of choice. Adults are particularly safety conscious and regularly seek means for increasing their personal safety. This is particularly true while participating in heightened risk activities such as running or cycling on public or shared paths and roadways, and during decreased visibility conditions. Sneakers, skates, shoes, boots, and other footwear items that are adorned with lights give the wearer a distinct fashion identity and increases the wearer's visibility, thereby improving personal safety.

Known lighted footwear typically includes one or more light sources, such as light emitting diodes (LEDs), a power source such as a battery, and a switch to provide power to the light sources. Often, the light sources are located in the sole of the footwear item. A problem that has arisen with known lighted footwear is that the light sources tend to become inoperative relatively early in the life of the footwear item. It is believed that during the course of normal wear and tear, the connections between the light sources and the switch are broken. This leads to an unattractive appearance and diminished safety benefits, as the footwear item exhibits either partial or no illumination.

Further, known lighted footwear models are typically bulkier and heavier than non-lighted models as a result of the light and power sources required for their operation. Because the persons interested in wearing lighted footwear are typically concerned with appearance and weight, i.e., fashion and safety conscious individuals, increased bulk and weight present a disincentive to these individuals wearing these known models. As such, the intended benefits associated with illuminated footwear to date have not been fully realized.

Notwithstanding the usefulness of the above-described models, there still exists a need for reliable and durable illuminated footwear assemblies that provide the benefit of illumination without the added bulk and weight associated with known models.

### DISCLOSURE OF THE INVENTION

The present invention in at least one embodiment provides a illuminated footwear item comprising a footwear upper; a sole assembly affixed to said upper, the sole assembly including an illumination assembly comprising a plurality of light sources connected to a conductor, said light sources and said conductor being encapsulated in a flexible, translucent casing; a control circuit connected to said plurality of light sources to control operational modes of said light sources; and, a translucent structural layer including a tubular aperture that extends along a perimeter of said layer, said illumination assembly being disposed in said aperture.

The present invention in at least one embodiment provides a sole assembly for a footwear item, comprising a footwear outsole; an structural layer connected to said outsole, said structural layer having at least a translucent portion and at least one indentation along a perimeter of said structural layer; and an illumination assembly connected to said structural layer, wherein said illumination assembly engages said indentation.

The present invention in at least one embodiment provides a method of making a footwear item, comprising providing an outsole; attaching an illumination assembly to said outsole, said illumination assembly comprising a plurality of light sources connected to a conductor, said light sources and said conductor being encapsulated in a casing; a control circuit connected to said plurality of light sources to control operational modes of said light sources; and a translucent structural layer including a tubular aperture that extends along a perimeter of said layer, said illumination assembly being disposed in said aperture; and attaching an upper to said illumination assembly or outsole.

An objective of the present invention in at least one embodiment is to provide illuminated footwear items that provide distinguished fashion appeal and improved safety. Another objective of the present invention is to provide illuminated footwear items that are resilient and dependable and avoid the known problems of unreliability, and increased bulk and weight associated with other illuminated footwear models.

An advantage of the present invention in at least one embodiment is that it overcomes the affect of other known illuminated footwear models in provided undesired bulk and weigh to the footwear item. The present invention also overcomes the lack of reliability in other known illuminated footwear due to circuitry and lighting failures by providing a unique sole assembly that securely supports the illumination assembly. The illumination assembly, including the control circuit and light sources, is encased and protected in a flexible, resilient polymer-like material that is placed in a trough on a perimeter of the sole structure such that the impact of force from the foot is significantly avoided, thereby increasing the life span and reliability of the assembly.

### BRIEF DESCRIPTION OF THE DRAWINGS

The present invention is described with reference to the accompanying drawings, wherein:

FIG. 1A illustrates an illuminated footwear item in accordance with an exemplary embodiment of the present invention.

FIG. 1B illustrates an exemplary sole assembly of the footwear item of FIG. 1A.

FIG. 2 illustrates a footwear item in accordance with an exemplary embodiment of the present invention having a side-mounted switch.

FIG. 3 illustrates a footwear item in accordance with an exemplary embodiment of the present invention having a tongue-mounted switch.

FIG. 4 illustrates an illumination assembly in accordance with an exemplary embodiment of the present invention.

FIG. 5 illustrates an illumination assembly in accordance with another exemplary embodiment of the present invention.

FIG. 6 illustrates an illumination assembly in accordance with still another exemplary embodiment of the present invention.

FIG. 7 illustrates a footwear item in accordance with still another exemplary embodiment of the present invention.

Given the following enabling description of the drawings, the apparatus should become evident to a person of ordinary skill in the art.

### DETAILED DESCRIPTION OF THE DRAWINGS

The present invention is directed to illuminated footwear assemblies and methods of manufacturing illuminated footwear assemblies that offer durable and reliable illumination that enhances the distinctiveness and safety of users. The footwear item of the present invention preferably includes an illumination assembly having a plurality of light sources and circuitry for controlling the plurality of light sources, one or more user-actuatable illuminated regions, e.g. the sole, the tongue and/or the footwear upper, and a power source coupled to the illumination assembly.

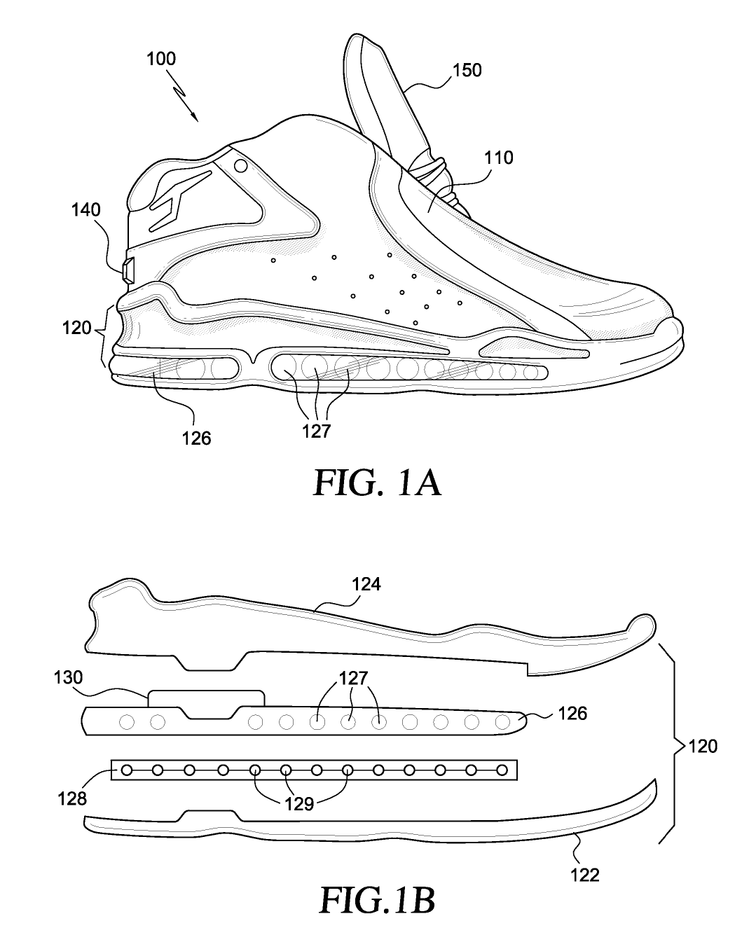

FIG. 1A illustrates an exemplary footwear item 100 in accordance with the present invention. Footwear item 100 includes a sole assembly 120 attached to an upper 110, including a tongue 150. An illumination assembly (not shown) is disposed within sole assembly 120. Sole assembly 120 includes a translucent structural layer 126, through which light from the illumination assembly is visibly transmitted to an exterior of the translucent structural layer 126. The translucent structural layer 126 may also include voids or apertures 127 formed along a perimeter. A user actuatable switch 140 that activates and deactivates the illumination assembly may also be located on the footwear item 110, for example, on a rear portion of upper 110 proximate the Achilles heel.

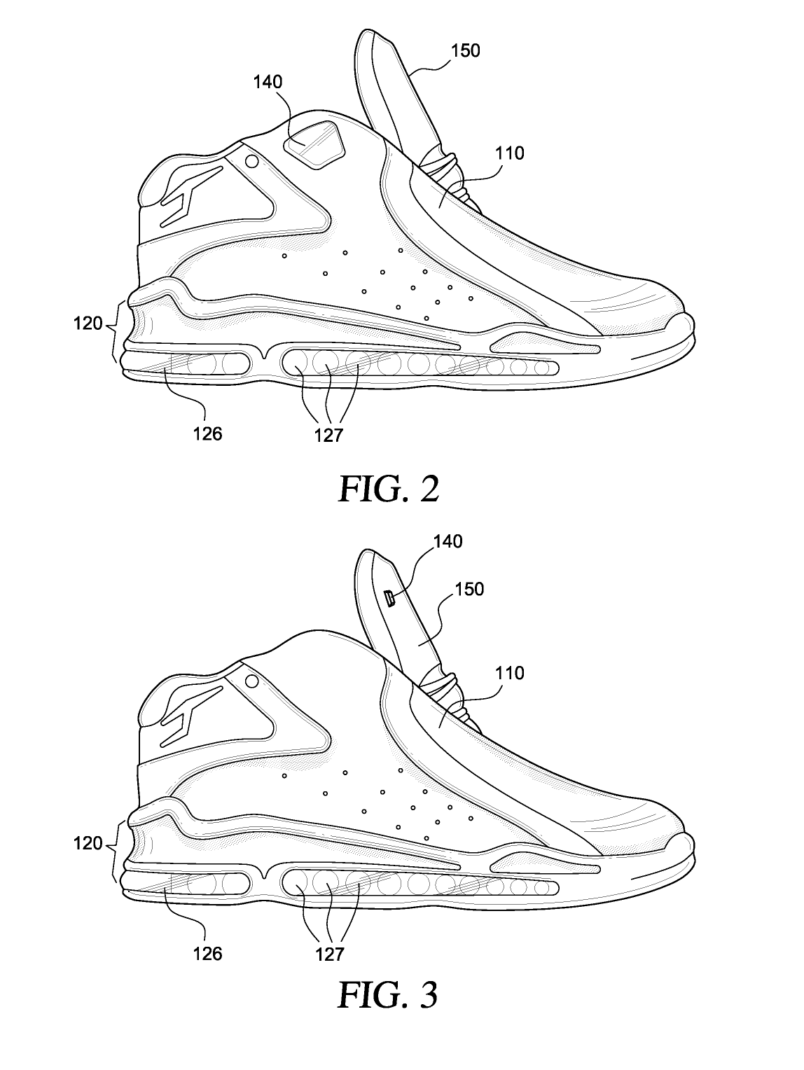

FIG. 1A illustrates an exemplary embodiment of sole assembly 120, outlined in FIG. 1A above. Sole assembly 120 includes translucent or transparent structural layer 126, e.g., a conventional bubble used in athletic shoes, sandwiched between an outsole 122 and a midsole 124. An Illumination assembly 128, including light sources 129, is disposed in structural layer 126 such that light is transmitted from illumination assembly 128 through structural layer 126 and/or apertures 127. Light sources may include light emitting diodes (LEDs), fiber optic strands, or similar light sources. Sole assembly 120 may alternatively include only outsole 122 and structural layer 126 or only midsole 124 and structural layer 126. Illumination assembly 128 may operate in a variety of user selectable operational or illumination modes. The footwear item may be provided with a user actuatable switch 140 that is connected to illumination assembly 128 in order to activate and deactivate the assembly. User actuatable switch 140 may be located in a variety of positions on the footwear item 100. For example, as illustrated in FIG. 2, user actuatable switch 130 may be located on a side portion of upper 110 and concealed within the material of upper 110. While in other embodiments, user actuatable switch 140 may be disposed within the tongue 150, as shown in FIG. 3. Various kinds of user actuatable switches are suitable for the footwear item of the present invention. Accordingly, user actuatable switch may be a push-button switch, a toggle switch, a sliding switch, a pressure sensitive switch, etc. For ease of mode selection, a push button switch may be preferred in embodiments in which the illumination assembly operates in a plurality of modes.

Footwear items in accordance with the invention may be constructed by forming and connecting sole assembly 120 to a shoe upper 110. An exemplary sole assembly may be formed by lodging illumination assembly 128 in structural layer 126, affixing outsole 122 to structural layer 126 and affixing midsole 124 to the combination of structural layer 126 and outsole 122 such that structural layer 126 is sandwiched therebetween. As is evident to those of skill in the art, if desired, one or both of midsole 124 and outsole 122 may be eliminated from sole assembly 120.

The battery or power source 130 for illumination assembly 128 may be disposed anywhere in the footwear item 100. To further reduce unwanted battery disconnections, in one embodiment, the battery 130 is disposed in tongue 150 of the footwear item 100. For example, tongue 150 may be provided with a pouch of sufficient size to house the battery. In this embodiment, a control circuit (not shown) may be embedded in illumination assembly 128 and disposed in translucent structural layer 126 of sole assembly 120, for example in the heel portion of outsole 122 and connected to the battery 130 and to LEDs 129.

As is customary in the art, midsole 124 may be constructed from one or more of the following materials: EVA (Ethylene Vinyl Acetate) foam, Phylon, Polyurethane, and Phylite. Outsole 122 may be constructed from any combination of one or more of the following materials: BRS 1000 or Carbon Rubber, solid rubber, DRC (durable rubber compound), Duralon or Gum Rubber. Structural layer 126 may comprise a urethane material that typically incorporates one or more air bladders.

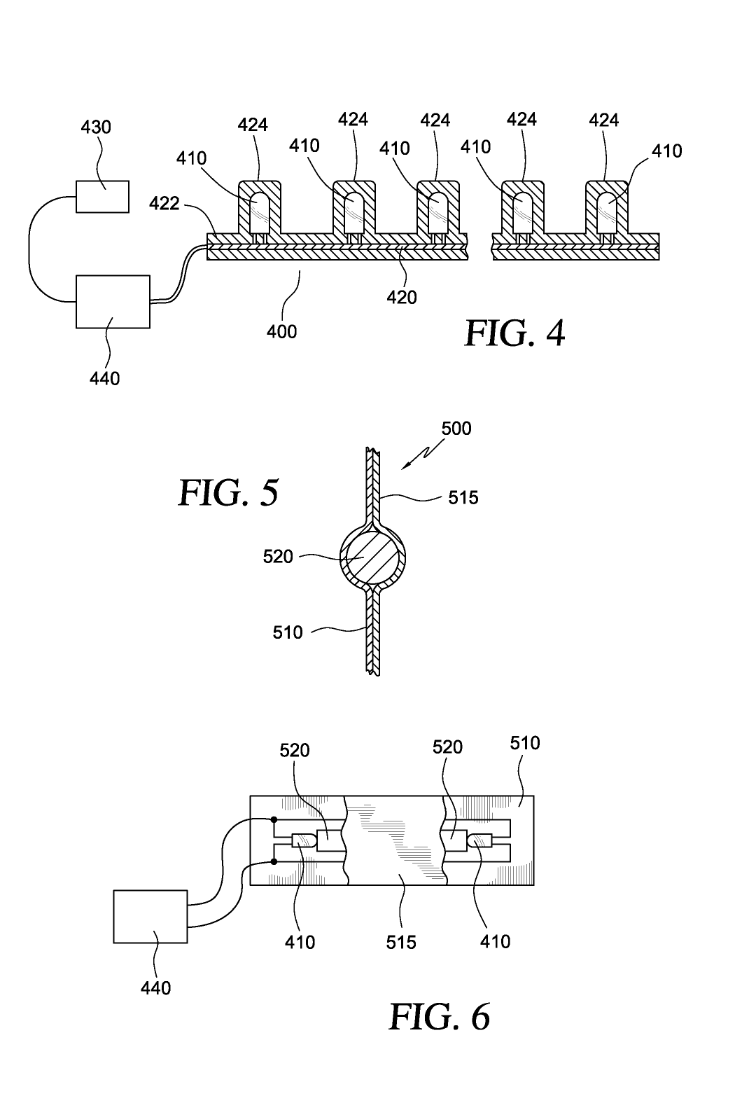

FIG. 4 illustrates an exemplary illumination assembly 400 in accordance with an embodiment of the present invention. Illumination assembly 400 includes a plurality of LEDs 410 interconnected by a conductor 420, for example a thin, flexible circuit board strip. In the illustrated embodiment, LEDs 410 and conductor 420 are encapsulated by a clear, flexible, polymer-like material 422. Further, the LEDs 410 may be surrounded by raised projections 424 of the polymer-like material 422. These projections 424, which may be in a variety of shapes and configurations, provide both additional protection of the LEDs 410 and a means to secure the illumination assembly 422 with corresponding engagement formations on the structural layer 126. Accordingly, the entire illumination assembly 400 is durably and flexibly encased and protected. Due to this added durability and flexibility, the illumination assembly 400 can be disposed in a shoe bubble, for example, and bent around a portion or the entire perimeter of a shoe without risk of failure.

Conductor 420 preferably comprises a flexible circuit strip such as the ReelFlex® flexible circuit available from Sheldahl Corporation of Northfield Minn., the flexible circuits available from Allflex, Inc. of Northfield, Minn., and the flexible circuit available from Rogers Corporation of Chandler, Ariz. under the R/flex 1000 tradename. The foregoing is not intended to be restrictive and conductor 420 may comprise other flexible circuits known to those of skill in the art.

In some embodiments, illumination assembly 400 may be threaded through an aperture that runs along the perimeter of transparent structural layer 126 without significantly extending inward in sole assembly 120. Accordingly, illumination assembly 128 is spared from bearing the bulk of the force exerted by a user's foot and thereby extending the operational life of illumination assembly 128.

Illumination assembly 400 further includes a control circuit 440 for controlling operation of LEDs 410. Control circuit 440 may be disposed anywhere on the footwear item and electrically connected to conductor 420. Control circuit 440 is coupled to switch 140 and, upon actuation of the switch, drives LEDs 410 in one or more operational or illumination modes. A power source 430 is connected to and drives control circuit 440. A suitable power source 430 includes a battery, e.g., a 9-volt battery; however, other power sources may be employed, if desired. In accordance with an embodiment of the invention, conductor 420 may be provided with one or more buses or other connection mechanisms that interconnect LEDs 410 with power source 430. Although a simple series connection of LEDs 410 is illustrated in FIG. 4, in keeping with the invention, two or more LEDs 420 may be variously connected in series or parallel.

A variety of desirable visual effects may be created based on the selection of operational or illumination mode. Accordingly, control circuit 440 may be configured to drive LEDs 410 in any desired illumination mode. Exemplary illumination modes include a continuous illumination mode, flashing illumination mode where one or more of LEDs 410 flash at regular or irregular intervals, a sequential illumination mode where LEDs 410 are illuminated in a predetermined or random sequence, and the like. The details of control circuit 440 are not shown or described herein because control circuits suitable for driving LEDs 410 in various illumination modes are known to persons of ordinary skill in the art. Exemplary illumination circuits are described in U.S. Pat. No. 5,663,614; U.S. Pat. No. 5,812,063 and U.S. Pat. No. 6,906,472 B2.

Likewise, a variety of desired visual effects may be achieved by the arrangement of LEDs 410. LEDs 410 may be of uniform characteristics, e.g., color, shape and intensity, or of different characteristics. Thus, depending upon the visual effect desired, LEDs 410 of like color may be grouped together or LEDs 410 may be arranged to form a color pattern. Likewise, LEDs of like intensity may be grouped together or LEDs 410 may be arranged in a pattern of varying intensities.

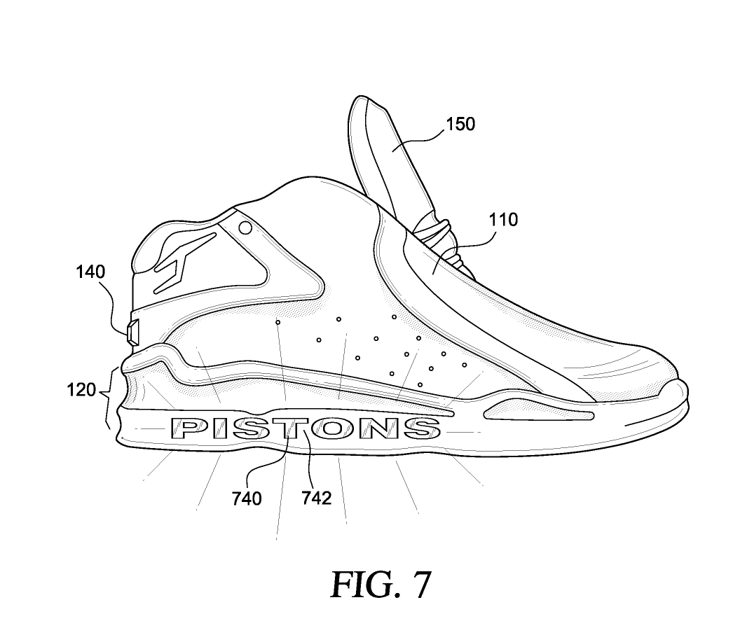

In accordance with another embodiment, as depicted in FIG. 5, illumination assembly 500 may comprise a backing strip 510 and a front strip 515 forming a tubular opening into which light-transmitting device 520 is disposed. To facilitate light transmission, LEDs 410 may be positioned between backing strip 510 and front strip 515 proximate to light transmitting device 520 and electrically connected to control circuit 440. In one embodiment, as more clearly illustrated in FIG. 7, a single LED 410 is disposed contiguous to an end of light transmitting device 520 or embedded in an end of light transmitting device 520 and electrically connected to the control circuit 440. However, in some embodiments, LED 410 may be slightly spaced from an end of light transmitting device 520. Light transmitting device 520 includes one or more elongated members of substantially transparent or clear, flexible material. More particularly, light-transmitting device 520 may comprise a rod or bar of translucent polymeric material similar to a large fiber optic cable. While in other embodiments, a plurality of light transmitting devices 520 may be disposed in the tubular opening in an end-to-end configuration having one or more LEDs 410 disposed between respective ends of light transmitting devices 520. Suitable materials include hot-melt adhesives including ethylene-vinyl acetate adhesives, polyethylenes, polyamides, block copolymer, and APAO. Each of these materials has great flexibility and a high degree of clarity or transparency. The length of the elongated member may be selected according to the degree of light transmission desired and the orientation and number of LEDs in the illumination device.

To maximize light output, backing strip 510 may be formed of an opaque, light reflective material and front strip 515 may be formed from a translucent material. In such an embodiment, illumination assembly 500 is disposed in the translucent structural layer 126 of the sole assembly 120, such that front strip 515 abuts the perimeter surface of translucent layer 126.

In connection with another aspect of the invention, as illustrated in FIG. 7, sole assembly 120 may be entirely translucent or may include translucent regions 740 variously shaped and arranged to maximize desirable visual effects. FIG. 7 shows translucent regions 740 separated by generally opaque barriers 742. In some applications, translucent regions 740 may be in the shape of a design, such as a logo, or alphanumeric characters arranged to display a message, i.e., a word, phrase or a numeric phrase. Exemplary messages include, but are not limited to, the shoe manufacturer's name, the wearer's name, a team, university or organization name, or an athlete's number.

The translucent regions 740 may be illuminated according to a number of different patterns. In keeping with one aspect of the invention, the translucent regions may be illuminated substantially uniformly or different regions may be illuminated to different intensity levels. In accordance with still another aspect of the invention, the translucent regions may be illuminated synchronously, sequentially or according to any desired pattern.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

### INDUSTRIAL APPLICABILITY

Exemplary footwear items of the invention include, but are not limited to, athletic shoes, casual shoes, casual boots, heavy-duty boots such as hiking boots or ski boots, in-line and four-wheeled skates, slippers, thongs or flip-flops, etc. Described below is an illustrative embodiment of an athletic shoe and a sole assembly for the athletic shoe in accordance with the invention.

We claim:

1. A illuminated footwear item comprising:
a footwear upper;
a sole assembly affixed to said upper, the sole assembly including an illumination assembly comprising:
a plurality of light sources connected to a conductor, said light sources and said conductor being encapsulated in a casing;
a control circuit connected to said plurality of light sources to control operational modes of said light sources; and
a translucent structural layer including a tubular aperture that extends along a perimeter of said layer, said illumination assembly being disposed in said aperture.

2. The illuminated footwear item of claim 1, wherein said illumination assembly transmits light through said translucent structural layer to an exterior of said translucent structural layer.

3. The illuminated footwear item of claim 2, wherein said translucent structural layer comprises an air bubble bladder sandwiched between a midsole and an outsole.

4. An illuminated footwear item of claim 3, wherein said air bubble bladder includes horizontal apertures extending from an interior of said bladder to the perimeter of said bladder, wherein light is transmitted along said apertures to an exterior of said bladder.

5. The illuminated footwear item of claim 1, wherein said casing comprises a durable and flexible polymer-like material that protects said conductor and said light sources.

6. The illuminated footwear item of claim 1, wherein said light sources comprise light emitting diodes (LEDs).

7. The illuminated footwear item of claim 1, further comprising a user actuatable switch coupled to said control circuit, wherein said user actuatable switch activates and deactivates said illumination assembly.

8. The illuminated footwear item of claim 1, wherein said footwear item comprises athletic shoes, casual shoes, boots and skates.

9. A illuminated footwear item comprising:
a footwear upper;
a sole assembly affixed to said upper, the sole assembly including an illumination assembly comprising:
a plurality of light sources connected to a conductor, said light sources and said conductor being encapsulated in a casing;
a control circuit connected to said plurality of light sources to control operational modes of said light sources; and
a translucent structural layer including a tubular aperture that extends along a perimeter of said layer, said illumination assembly being disposed in said aperture.

10. The sole assembly for a footwear item of claim 9, further comprising a midsole connected to said structural layer or said outsole.

11. The sole assembly for a footwear item of claim 9, wherein said illumination assembly transmits light through said translucent portion of said structural layer to an exterior of said structural layer.

12. The sole assembly for a footwear item of claim 11, wherein said structural layer comprises an air bubble bladder sandwiched between said midsole and said outsole.

13. The sole assembly for a footwear item of claim 12, wherein said air bubble bladder includes horizontal apertures extending from an interior of said bladder to the perimeter of said bladder, wherein light is transmitted along said apertures to an exterior of said bladder.

14. The sole assembly for a footwear item of claim 9, wherein said casing comprises a durable and flexible polymer-like material that protects said conductor and light sources.

15. The sole assembly for a footwear item of claim 9, wherein said light sources comprise light emitting diodes (LEDs).

16. The sole assembly for a footwear item of claim 9, further comprising a user actuatable switch coupled to said control circuit, wherein said user actuatable switch activates and deactivates said illumination assembly.

17. The sole assembly for a footwear item of claim 9, wherein said footwear item comprises athletic shoes, casual shoes, boots and skates.

18. A method of making a footwear item, comprising:
providing an outsole;
attaching an illumination assembly to said outsole, said illumination assembly comprising:
a plurality of light sources connected to a conductor, said light sources and said conductor being encapsulated in a casing;
a control circuit connected to said plurality of light sources to control operational modes of said light sources; and
a translucent structural layer including a tubular aperture that extends along a perimeter of said layer, said illumination assembly being disposed in said aperture; and
attaching an upper to said illumination assembly or outsole.

19. The method of making a footwear item of claim 18, further comprising disposing a midsole between said outsole and said upper.

20. The method of making a footwear item of claim 18, further comprising coupling a user actuatable switch to said control circuit, wherein said switch activates and deactivates said illumination assembly.
